(19) United States
(12) Patent Application Publication
(10) Pub. No.: US 2025/0030111 A1
(43) Pub. Date: Jan. 23, 2025

(54) BATTERY MODULE

(71) Applicant: SAMSUNG SDI CO., LTD., Yongin-si (KR)

(72) Inventors: Jongpil LEE, Yongin-si (KR); Gangya PARK, Yongin-si (KR)

(21) Appl. No.: 18/766,900

(22) Filed: Jul. 9, 2024

(30) Foreign Application Priority Data
Jul. 21, 2023 (KR) 10-2023-0095516

(51) Int. Cl. H01M 50/287; H01M 10/42; H01M 50/209; H01M 50/271; H01Q 1/22

(52) U.S. Cl. CPC H01M 50/287; H01M 10/425; H01M 50/209; H01M 50/271; H01Q 1/22; H01M 2010/4278

(57) ABSTRACT

A battery module includes a plurality of unit cells arranged in a first direction and a top cover covering the plurality of unit cells in a second direction crossing the first direction. The top cover includes a cover main body having a through hole and an antenna part attached to a rear surface of the cover main body such that the antenna part covers the through hole between the cover main body and the plurality of unit cells.

### CROSS-REFERENCE TO RELATED APPLICATION

This application claims priority to and the benefit of Korean Patent Application No. 10-2023-0095516 filed in the Korean Intellectual Property Office on Jul. 21, 2023, the entire contents of which are incorporated herein by reference.

### BACKGROUND

### (a) Field

The present disclosure relates to a battery module.

### (b) Description of the Related Art

A rechargeable battery is a battery that is repeatedly charged and discharged.

A conventional battery module includes a plurality of unit cells arranged in one direction, a case accommodating the plurality of unit cells therein, and an antenna part for wirelessly communicating a wireless signal related to the plurality of unit cells with outside of the battery module.

However, in the conventional battery module, when the antenna part is positioned inside the case, a radio wave from the antenna part may be shielded by the case and wireless communication thereby being disabled. But, when the antenna part is positioned outside the case, the antenna part may be damaged by interference.

### SUMMARY

The present disclosure is to provide a battery module having stable wireless communication with outside of the battery module by including a top cover containing an antenna part.

The present disclosure is to provide a battery module including a plurality of unit cells arranged in a first direction and a top cover covering the plurality of unit cells in a second direction crossing the first direction, wherein the top cover includes a cover main body that includes a through hole and an antenna part which is attached to a rear surface of the cover main body, the antenna part being positioned between the through hole and the plurality of unit cells.

The antenna part is exposed by the through hole to outside of the battery module in the second direction.

The top cover may further include a sealing part that bond between the rear surface of the cover main body and the antenna part.

The sealing part may be positioned between the antenna part and the rear surface of the cover main body along an edge of the antenna part.

The top cover may further include a second sealing part being adjacent to the first sealing part and bonded between the rear surface of the cover main body and the antenna part.

The second sealing part may be adjacent to the first sealing part and may be positioned between the antenna part and the rear surface of the cover main body along an edge of the antenna part.

A bus bar positioned between the plurality of unit cells and the top cover and connected to terminals of the plurality of unit cells may be further included.

A control part positioned between the top cover and the busbar and connected to the busbar and the antenna part may be further included.

The control part may exchange signals with outside of the battery module through the antenna part.

The antenna part may include an antenna printed circuit board.

A pair of end plates that are positioned at ends of the plurality of unit cells in the first direction and supporting the plurality of unit cells may be further included.

A pair of side plates which support the plurality of unit cells at ends of the plurality of unit cells in a the third direction that crosses the first direction and the second direction may be further included.

A side insulation positioned between the plurality of unit cells and the side plates may be further included.

The through hole may be positioned in at a center of the cover main body.

The through hole is in the shape of one of a circle, an ellipse, a triangle, a square, and a polygon.

According to another embodiment, a battery module includes a container providing an internal space, the container including a cover having a through hole, a plurality of unit cells positioned in the internal space of the container; and an antenna part connected to a surface the cover that faces the internal space such that the antenna part is positioned between the through hole and the plurality of unit cells.

The container includes a plurality of side plates arranged on opposite sides of the plurality of unit cells, a plurality of end plates arranged at opposite ends of the plurality of unit cells.

The present disclosure provides a battery module having stable wireless communication with outside of a battery module by including a top cover containing an antenna part.

### BRIEF DESCRIPTION OF THE DRAWINGS

FIG. 1 is a perspective view illustrating a battery module according to an embodiment.

FIG. 2 is an exploded perspective view showing a battery module according to an embodiment.

FIG. 3 is a perspective view illustrating a front surface of a top cover of a battery module according to an embodiment.

FIG. 4 is a perspective view illustrating a rear surface of a top cover of a battery module according to an embodiment.

FIG. 5 is a cross-sectional view taken along V-V of FIG. 3.

FIG. 6 is a cross-sectional view illustrating a part of a top cover of a battery module according to another embodiment.

### DETAILED DESCRIPTION OF THE EMBODIMENTS

Hereinafter, the present disclosure will be described in detail with reference to the accompanying drawings so that those of ordinary skill in the technical field to which this disclosure belongs can easily implement it. The present disclosure may be implemented in various different forms and is not limited to the embodiments described herein.

Throughout the specification, when a part “comprises” or “includes” a component, it means that it may comprises or include more other components, rather than excluding other components, unless otherwise stated in opposition.

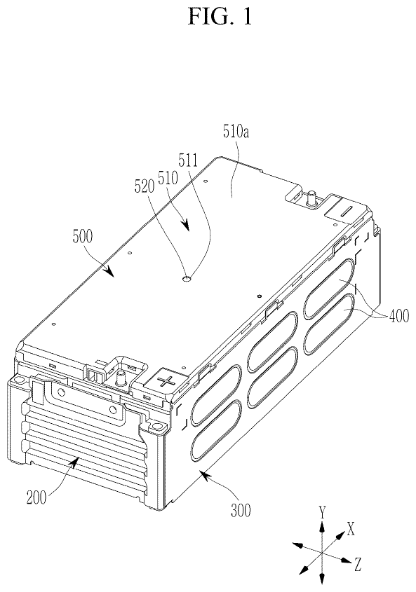

Hereinafter, a battery module according to an embodiment will be described with reference to FIG. 1 to FIG. 5.

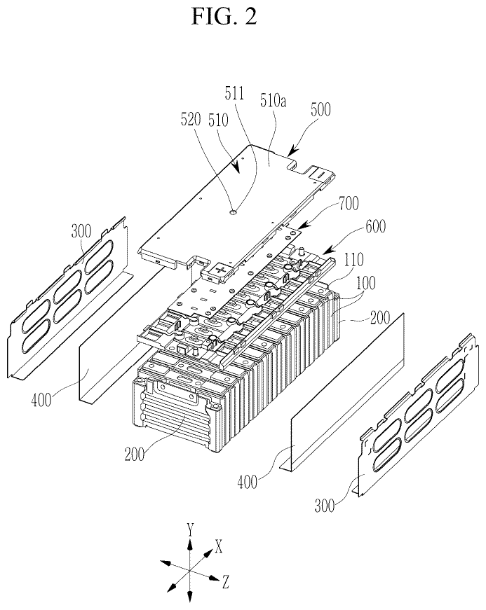

FIG. 1 is a perspective view illustrating a battery module according to an embodiment. FIG. 2 is an exploded perspective view showing a battery module according to an embodiment.

Referring to FIG. 1 and FIG. 2, a battery module according to an embodiment may include a plurality of unit cells 100, a pair of end plates 200, a pair of side plates 300, a pair of side insulations 400, a top cover 500, a busbar 600, and a control part 700.

A plurality of unit cells 100 may be arranged in the first direction X to be electrically connected to each other. Each of the plurality of unit cells 100 includes various known rechargeable batteries that may be charged and discharged. For example, each of the plurality of unit cells 100 may include a lithium ion battery, but is not limited thereto, and may include, for example, a lithium polymer battery or the like.

Herein, each of the first direction X, the second direction Y, and the third direction Z may mean directions crossing each other, and the directions crossing each other may mean directions perpendicular to each other, but is not limited thereto. For example, the second direction Y may intersect the first direction X, and the third direction Z may intersect the first direction X and the second direction Y.

Each of a plurality of unit cells 100 may include a terminal 110. The terminals 110 of each of the plurality of unit cells 100 may be positioned on a long side of the unit cell 100, and a plurality of terminals 110 of the plurality of unit cells 100 may be electrically connected to each other by a bus bar 600. Meanwhile, in another embodiment, the terminal 110 of each of the plurality of unit cells 100 may be positioned on the short side of the unit cell 100, and the terminal 110 may have various known terminal structures.

The pair of end plates 200 may be positioned at both ends in the first direction X and support a plurality of unit cells 100. The end plates 200 may be provided in a pair and are disposed at both ends in the first direction X to support the outermost unit cell 100 among the plurality of unit cells 100. The end plate 200 may include a metal such as stainless steel and aluminum, but is not limited thereto. An insulating material may be positioned between the end plates 200 and the plurality of unit cells 100, and, thus, the end plate 200 may be insulated from the plurality of unit cells 100. The pair of end plates 200 may be coupled to the top cover 500 covering a plurality of unit cells 100 in a second direction Y crossing the first direction X, but is not limited thereto.

The pair of side plates 300 may support a plurality of unit cells 100 at both ends of the third direction Z crossing the first direction X and the second direction Y. The pair of side plates 300 may be connected to the pair of end plates 200 at both ends in the third direction Z and may be spaced apart from the plurality of unit cells 100 at a predetermined interval, but is not limited thereto. The pair of side plates 300 may be connected to the pair of end plates 200 to accommodate and support a plurality of unit cells 100. The pair of side plates 300 may be coupled to the top cover 500 but are not limited thereto. A bus bar 600 and a control part 700 may be positioned above a plurality of unit cells 100 accommodated in an internal space defined by a pair of end plates 200 and the pair of side plates 300 that are connected to the top cover 500. A top cover 500, which is connected to the pair of end plates 200 and the pair of side plates 300, may be positioned on the control part 700. The side plate 300 may include a metal such as stainless steel and aluminum, but is not limited thereto. Each of a pair of side insulations 400, which is an insulating member, may be positioned between each of the pair of side plates 300 and the plurality of unit cells 100.

The side insulation 400 may be an insulating member positioned between each of the plurality of unit cells 100 and the pair of side plates 300. The side insulation 400 may be adhered to the side plate 300 by an adhesive part such as an adhesive tape, but is not limited thereto.

The top cover 500 may be connected to the end plates 200 and the side plates 300 to cover upper portions of the unit cells 100 in a second direction Y crossing the first direction X and the third direction Z.

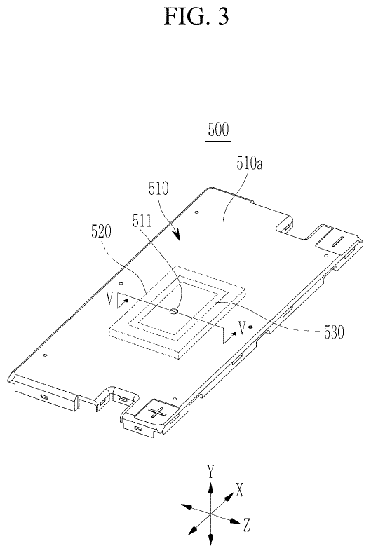

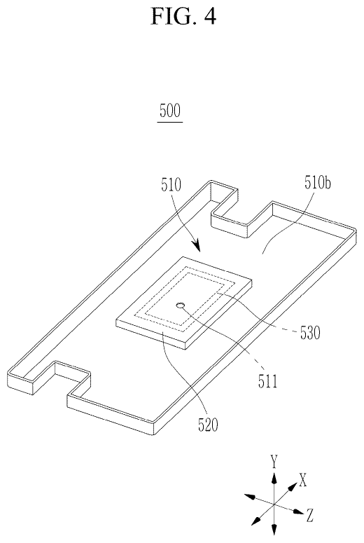

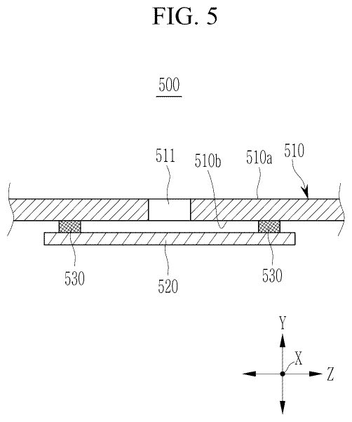

FIG. 3 is a perspective view illustrating a front surface of a top cover of a battery module according to an embodiment. FIG. 4 is a perspective view illustrating a rear surface of a top cover of a battery module according to an embodiment. FIG. 5 is a cross-sectional view taken along V-V of FIG. 3.

Referring to FIG. 2 to FIG. 5, the top cover 500 may include a cover main body 510, an antenna part 520, and a first sealing part 530.

The cover main body 510 may include a front surface 510a exposed to the outside of the battery module, a rear surface 510b exposed to the inside of the battery module and facing the plurality of unit cells 100, and a through hole 511 extending between the front surface 510a and the rear surface 510b.

The through hole 511 may be positioned in a central area of the cover main body 510. The through hole 511 may extend between the front surface 510a from the rear surface 510b of the cover main body 510 to thereby expose the antenna part 520 in the second direction Y. The through hole 511 may expose a part of the antenna part 520 in which wireless communication is performed, but is not limited thereto. The through hole 511 may be in the shape of a circle in a plan view, but is not limited thereto and may, for example, be in the shape of an ellipse, a triangle, a square, and a polygon. The through hole 511 may expose a part of one antenna part 520 corresponding to one antenna part 520, but is not limited thereto. For example, the through hole 511 may include a plurality of sub through holes exposing each of a plurality of antenna parts or each of a plurality of portions of the antenna parts. As another example, the through hole 511 may have a shape corresponding to the shape of the antenna formed in the antenna part 520. When the shape of the antenna is circular, it may have a circular shape corresponding thereto, or when the shape of the antenna is triangular, it may have a triangular shape corresponding thereto.

The antenna part 520 may be attached to the rear surface 510b of the cover main body 510. The antenna part 520 may be positioned between the through hole 511 and a plurality of unit cells 100 in the second direction Y. As such, the antenna part 520 covers the through hole 511 in the second direction Y. The antenna part 520 may be attached to the rear surface 510b of the cover main body 510 by the first sealing part 530, but is not limited thereto, and may, for example, be attached to the rear surface 510b of the cover main body 510 by a separate adhesive part. The antenna part 520 may be positioned between the cover main body 510 and the control part 700. The antenna part 520 may be connected to the control part 700 through various known connection means to wirelessly transmit a signal the antenna part 520 receives from the control part 700 to outside of the battery module, or transmit a signal wirelessly received from outside of the battery module to the control part 700. Here, various known battery control parts for exchanging battery-related signals with the control part 700 of the battery module may be provided outside of the battery module. The antenna part 520 may include an antenna printed circuit board (PCB), and the antenna PCB may include a flexible printed circuit board FPCB including various known antennas.

The first sealing part 530 may bond between the rear surface 510b of the cover main body 510 and the antenna part 520 on the rear surface 510b of the cover main body 510. The first sealing part 530 may seal between the rear surface 510b of the cover main body 510 and the antenna part 520. The first sealing part 530 may be positioned between the antenna part 520 and the rear surface 510b of the cover main body 510 along the edge of the antenna part 520 to seal between the rear surface 510b of the cover main body 510 and the antenna part 520. In another embodiment, the first sealing part 530 may be positioned between the antenna part 520 and the rear surface 510b of the cover main body 510 along the edge of the through hole 511 to seal between the rear surface 510b of the cover main body 510 and the antenna part 520. The first sealing part 530 may have a rectangular ring shape in a plan view, but is not limited thereto, and may have various ring shapes such as a circular ring, an elliptical ring, a triangular ring, a rectangular ring, and a polygonal ring. The first sealing part 530 may be formed from a polymer material such as polypropylene, polyimide, or polyethylene, a metal material such as aluminum or copper, a glass material such as frit, or a ceramic material.

Referring to FIG. 2, the bus bar 600 may be positioned between the unit cells 100 and the top cover 500. The bus bar 600 may be connected to the terminals 110 of the unit cells 100. The bus bar 600 may have an assembly shape, but is not limited thereto, and may have various other structures.

The control part 700 may be positioned between the antenna part 520 of the top cover 500 and the bus bar 600. The control part 700 may be connected to the bus bar 600 and the antenna part 520 and may control the plurality of unit cells 100 by exchanging radio signals with outside of the battery module through the antenna part 520 or monitor the states of the unit cells 100. Here, outside of the battery module there may be various known battery control parts for exchanging battery-related signals with the control part 700 of the battery module. The control part 700 may include various rechargeable battery control means and various rechargeable battery monitoring means.

As described above, in the battery module according to one example, the antenna part 520 attached to the rear surface of the top cover 500 may be exposed to outside of the battery module by the through hole 511. As such, the antenna part 520 may be positioned inside the case including the top cover 500 to protect the antenna part 520 and prevent the antenna part 520 from being damaged. At the same time, wireless communication between the battery module and an external battery control part using the antenna part 520 may be stabilized because the antenna part can smoothly transmit and receive radio waves through the through hole 511.

Further, even as the antenna part 520 is attached to the rear surface of the top cover 500 and exposed by the through hole 511, the first sealing part 530 seals between the cover main body 510 and the antenna part 520 to thereby prevent external foreign substances penetrating into the battery module through the through hole 511.

Thus, by including a top cover comprising an antenna part 520 and a first sealing part 530, a battery module is provided in which wireless communication with the outside is stabilized, damage to the antenna part 520 may be prevented, and an internal shielding structure is formed.

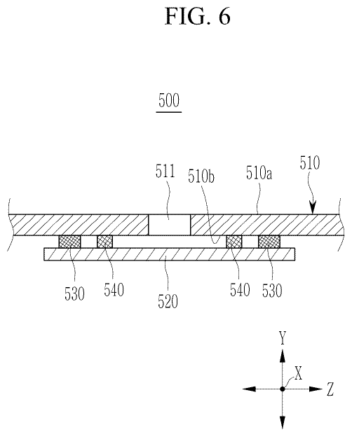

Hereinafter, a battery module according to another embodiment will be described with reference to FIG. 6. In particular, parts that are different from the above-described embodiment will be described.

FIG. 6 is a cross-sectional view illustrating a part of a top cover of a battery module according to another embodiment.

Referring to FIG. 6, a top cover 500 of a battery module according to another embodiment may include a cover main body 510, an antenna part 520, a first sealing part 530, and a second sealing part 540.

The second sealing part 540 may be positioned between the rear surface 510b of the cover main body 510 and the antenna part 520 and be adjacent to the first sealing part 530. The second sealing part 540 seals between the rear surface 510b of the cover main body 510 and the antenna part 520 together with the first sealing part 530. The second sealing part 540 may be positioned between the antenna part 520 and the rear surface 510b of the cover main body 510 adjacent to the first sealing part 530 along the edge of the antenna part 520, thereby sealing between the rear surface 510b of the cover main body 510 and the antenna part 520. In another embodiment, the second sealing part 540 may be positioned between the antenna part 520 and the rear surface 510b of the cover main body 510, adjacent to the first sealing part 530, and along the edge of the through hole 511 so that a gap between the rear surface 510b of the cover main body 510 and the antenna part 520 may be sealed. The second sealing part 540 may have a rectangular ring shape in a plan view, but is not limited thereto, and may have various ring shapes such as a circular ring, an elliptical ring, a triangular ring, a rectangular ring, and a polygonal ring. The second sealing part 540 maybe formed from a polymer material such as polypropylene, polyimide, or polyethylene, a metal material such as aluminum or copper, a glass material such as frit, or a ceramic material. In another embodiment, the second sealing part 540 may be formed from a material different from that of the first sealing part 530.

As described above, in the battery module according to an embodiment, the antenna part 520 attached to the rear surface of the top cover 500 may be exposed by the through hole 511. As such, the antenna part 520 may be positioned inside the casing including the top cover 500 to protect the antenna part 520 and prevent the antenna part 520 from being damaged. At the same time, wireless communication between the battery module and an external battery control part using the antenna part 520 may be stabilized by smoothly transmitting and receiving radio waves from the antenna part 520 through the through hole 511.

In addition, in the battery module according to another embodiment, even if the antenna part 520 attached to the rear surface of the top cover 500 is exposed by the through hole 511, the first sealing part 530 and the second sealing part 540 provide a double-seal between the cover main body 510 and the antenna part 520, thereby preventing external foreign substances from penetrating into the battery module through the through hole 511.

Thus, by including a top cover including an antenna part 520, a first sealing part 530, and a second sealing part 540, a battery module is provided in which wireless communication with the outside is stabilized, damage to the antenna part 520 is prevented, and an internal shielding structure is formed.

Although the embodiments of this disclosure have been described in detail above, the scope of this disclosure is not limited thereto, and various modifications and improvements of those skilled in the art using the basic concepts of this disclosure defined in the following claims, which also belong to the scope of this disclosure.

### DESCRIPTION OF SYMBOLS

unit cell 100, end plate 200, side plate 300, side insulation 400, top cover 500, cover main body 510, through hole 511, antenna part 520, busbar 600, control part 700

What is claimed is:

1. A battery module comprising:
a plurality of unit cells arranged in a first direction; and
a top cover covering the plurality of unit cells in a second direction crossing the first direction,
wherein the top cover comprises:
a cover main body including a through hole; and
an antenna part attached to a rear surface of the cover main body, the antenna part being positioned between the through hole and the plurality of unit cells.

2. The battery module as claimed in claim 1, wherein the antenna part is exposed by the through hole to outside of the battery module in the second direction.

3. The battery module as claimed in claim 1, wherein the top cover further comprises a sealing part that bonds the rear surface of the cover main body and the antenna part.

4. The battery module as claimed in claim 3, wherein the sealing part is positioned between the antenna part and the rear surface of the cover main body along an edge of the antenna part.

5. The battery module as claimed in claim 3, wherein the sealing part is a first sealing part, and
wherein the top cover further comprises a second sealing part bonding the rear surface of the cover main body and the antenna part adjacent to the first sealing part.

6. The battery module as claimed in claim 5, wherein the second sealing part is adjacent to the first sealing part and is positioned between the antenna part and the rear surface of the cover main body along an edge of the antenna part.

7. The battery module as claimed in claim 1, further comprising a bus bar positioned between the plurality of unit cells and the top cover, the bus bar being connected to terminals of the plurality of unit cells.

8. The battery module as claimed in claim 7, further comprising a control part positioned between the top cover and the bus bar, the control part being connected to the antenna part.

9. The battery module as claimed in claim 8, wherein the control part exchanges signals with outside of the battery module through the antenna part.

10. The battery module as claimed in claim 1, wherein the antenna part comprises an antenna printed circuit board.

11. The battery module as claimed in claim 1, further comprising a pair of end plates positioned at ends of the plurality of unit cells in the first direction and supporting the plurality of unit cells.

12. The battery module as claimed in claim 11 further comprising a pair of side plates supporting the plurality of unit cells at ends of the plurality of unit cells in a third direction that crosses the first direction and the second direction.

13. The battery module as claimed in claim 12, further comprising side insulation positioned between the plurality of unit cells and the side plates.

14. The battery module as claimed in claim 1, wherein the through hole is positioned at a center of the cover main body.

15. The battery module as claimed in claim 14, wherein the through hole is in the shape of one of a circle, an ellipse, a triangle, a quadrangle, and a polygon.

16. A battery module comprising:
a container providing an internal space, the container including a cover having a through hole,
a plurality of unit cells positioned in the internal space of the container; and
an antenna part connected to a surface the cover that faces the internal space such that the antenna part is positioned between the through hole and the plurality of unit cells.

17. A battery module as claimed in claim 16, wherein the container includes a plurality of side plates arranged on opposite sides of the plurality of unit cells, a plurality of end plates arranged at opposite ends of the plurality of unit cells.
